(19) United States
(12) Patent Application Publication
(10) Pub. No.: US 2008/0181256 A1
(43) Pub. Date: Jul. 31, 2008

(54) Switched Digital Video Distribution Infrastructure and Method of Operation

(75) Inventors: Mayer D. Schwartz, Portland, OR (US); Forney Lee Buchanan, Aloha, OR (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/942,251

(22) Filed: Nov. 19, 2007

Related U.S. Application Data
(60) Provisional application No. 60/866,971, filed on Nov. 22, 2006.

(51) Int. Cl. H04J 3/22

(52) U.S. Cl. 370/486

(57) ABSTRACT

A switched digital video distribution infrastructure for selectively distributing transport streams each composed of encoded pictures for decoding and presentation employs a source apparatus to output a first program to a requesting destination device as a constrained bit rate transport stream, receive a program change request from the requesting destination device, and in response to the program change request, output a second program both as an unconstrained variable bit rate stream and as a constrained bit rate transport stream. The requesting destination device decodes the unconstrained variable bit rate transport stream, loads the second program's constrained bit rate transport stream into a decoder buffer until the decoder buffer contains sufficient data to allow the pictures of the second program's constrained bit rate transport stream to be decoded without the decoder buffer running dry. The destination device then commences reading the second program's constrained bit rate transport stream from the decoder buffer and decoding the pictures of the second program's constrained bit rate transport stream and discontinues decoding of the unconstrained variable bit rate transport stream.

### CROSS-REFERENCE TO RELATED APPLICATION

This application claims benefit of U.S. Provisional Application No. 60/866,971 filed Nov. 22, 2006, the entire disclosure of which is incorporated herein by reference for all purposes.

### BACKGROUND

This application relates to a switched digital video distribution infrastructure for selectively distributing transport streams, and to a method of operating a switched digital video infrastructure.

The single program MPEG-2 transport stream or MTS (as defined in ISO 13818-1), sometimes referred to simply as a transport stream, is composed of fixed length packets, each 188 bytes long and having a four byte header. The remaining 184 bytes are payload (video and audio data) or some combination of adaptation field and payload.

A conventional MPEG encoder for receiving uncompressed digital audio and video data and generating MTS packets may include an audio encoder that receives the audio data and produces an audio packetized elementary stream (PES), a video encoder that receives the video data and produces a video PES, a controller that generates timing and other control data, and a multiplexer that operates under control of the controller to select the audio PES, the video PES and the control data in the sequence that is required in order to compose the 188-byte MTS packets.

Transmitting data terminal equipment (DTE) may transmit MTS packets over an Internet Protocol (IP) network on a multicast address. The transmitting DTE includes a network interface driver that receives the MTS packets from the MPEG encoder and constructs an IP packet usually containing seven MTS packets. When the network interface driver receives a packet request, the network interface driver outputs an IP packet onto the network. The receiving DTE includes a network interface driver that receives a sequence of bits from the network as an IP packet and recovers the MTS packets from the IP packet and supplies the MTS packets to an MPEG decoder, which divides the incoming MTS packets into the audio PES, the video PES and control data, decodes the audio data and outputs the decoded audio data as a continuous stream, and decodes the video data and outputs the decoded video data as a continuous stream.

A digital video infrastructure for distributing internet protocol television (IPTV) is shown partially in FIGS. 1 and 2. The digital video infrastructure is partitioned between distributor premise equipment, which may be located at a satellite headend or further downstream closer to the subscriber (customer), and subscriber premise equipment located at subscriber premises. The distributor premise equipment includes network access equipment, such as a digital subscriber line (or digital subscriber loop) access multiplexer (DSLAM) 10, that is connected to the subscriber premise equipment 20, typically by conventional copper wire constituting a carrier network and local loops. The DSLAM receives compressed audio and video data as MPEG single program transport stream (TS) packets that are encapsulated in IP packets with their own multicast address corresponding one-to-one with the subscriber-selectable TV channels. Each MPEG transport stream conveys compressed audio and video data for a single TV channel. The subscriber premise equipment associates the channel selected by the subscriber with the appropriate multicast group.

FIG. 2 illustrates schematically the DSLAM 10, which comprises multiple stream input buffers 12 for the MPEG transport streams respectively and multiple subscriber output buffers 14 for the subscribers respectively. The IP packets of each incoming transport stream are loaded into the corresponding stream input buffer 12. The DSLAM also comprises memory read/write circuitry 16 implementing routing functionality by which the IP packets loaded into any stream input buffer 12 can be copied to any unique group of subscriber output buffers 14.

The DSLAM also includes a DSL modem 18 for each subscriber output buffer 14. The DSL modem 18 receives the IP packets from the subscriber output buffer 14 and uses the packet data to modulate a high frequency signal that is delivered to the subscriber premise equipment 20 over the carrier network and the subscriber's local loop.

An MPEG transport stream may be transmitted at a variable bit rate (VBR), or unconstrained bit rate, in which case the bit rate varies in a manner that allows an entire picture to be transmitted in the interval between two consecutive decode times, or at a constrained bit rate, which includes both constant bit rate (CBR) and a capped VBR mode, in which the bit rate is not sufficient to allow an entire picture to be transmitted in the interval between two consecutive decode times.

For illustrative purposes, it will be assumed in an exemplary case that the IP packets convey the TS packets at constant bit rate (CBR). In this case, the time taken to deliver the bits for a picture will vary depending on, among other things, whether the picture is a B picture, a P picture or an I picture. For NTSC, the average duration of a frame at CBR is 0.033 s whereas an I frame might have a duration of 0.1 s or longer.

The subscriber premise equipment 20 at each subscriber premise includes a DSL modem 22 which recovers the IP packets from the high frequency DSL signal and supplies the IP packets to a set top box (STB) 30 which is connected to a television set 26. The STB 30 includes a network interface driver 32 which receives the IP packets from the DSL modem 22 and outputs transport stream packets, and an MPEG decoder 34 which receives the transport stream packets. The MPEG decoder includes a decoder buffer into which the transport stream bits are loaded and from which the pictures are read for decoding and presentation.

The decoder buffer in the MPEG decoder is modeled in the encoder or other upstream transmitting equipment by a compressed video buffer, which is referred to as the VBV buffer in MPEG2 and the CPB in H.264. It is helpful to the proper operation of the STB that the decoder buffer should not run dry or underflow. Aspects of the present invention prevent the decoder buffer from running dry or overflowing by controlling the upstream transmitting equipment so that the encoder's compressed video buffer does not overflow.

The subscriber may use a conventional remote control unit 28 to issue commands to the STB to change the channel that is currently being presented by the television set. In the event that the subscriber issues a command for channel change, the STB sends internet group management protocol (IGMP) leave and join requests for the respective multicast groups of the channel being left and for the new requested channel. Thus, the STB requests that it leave the multicast group for stream 1 and join the multicast group for stream 2, for example. In response to the leave and join requests, the router ceases copying the IP packets of stream 1 to the output buffer associated with the requesting STB and instead copies the IP packets of stream 2 to the output buffer.

The rectangle 40 in FIG. 3 illustrates schematically the transport stream bits of a CBR stream v transmitted from the DSLAM to a subscriber's set top box. Time increases from left to right as indicated by the time axis at the bottom of the figure. The various shaded boxes vᵢ represent coded pictures of various sizes (in number of bits) and hence of various lengths in time. The first bit of coded picture vᵢ enters the buffer at time tᵢ.

It will be understood that there is a delay between the time of arrival of the first bit of a picture at the decoder and the time at which the picture can be decoded, since decoding cannot start until all bits of the picture are available and the buffer delay must be sufficient to accommodate the largest picture in the buffer at the constant bit rate.

Each TS packet containing bits of coded picture vᵢ also contains a decode time stamp value DTSᵢ that is associated with the picture and specifies the time at which the coded picture vᵢ can be safely decoded without the decoder buffer running dry so that the decoder has to repeat frames. The DTS values are shown in FIG. 3 along the time axis. The bits of coded picture vᵢ are removed from the buffer for decoding at time DTSᵢ.

The time difference DTSᵢ−tᵢ is the time from when the decoder reads the first bit of picture i until the decoder can start to decode picture i. The maximum value Ts of the time difference DTSᵢ−tᵢ is the minimum size of the compressed video buffer given in seconds and must be greater than the time taken to load the largest picture in the buffer at the constant bit rate.

The dashed rectangle 42 in FIG. 3 depicts the decoder buffer, which may be considered to move to the right relative to the transport stream bits with evolution of time. It will be appreciated that the dashed rectangle also represents the compressed video buffer. At the time Tx indicated in FIG. 3, all the bits of pictures v₋₂-v₁ are in the buffer, bits of the picture v₂ are entering the buffer, and all the bits of picture v₋₃ have been removed from the buffer for decoding.

Now suppose that at the time Tx the subscriber caused the STB to issue a request to change from the channel associated with stream v to the channel associated with stream w. The DSLAM will respond to the channel change request at the end of the current picture. Accordingly, at time t₃ the bit stream arriving at the STB decoder buffer will change from packets vᵢ to packets wᵢ. The buffer contains all the bits of picture v₂ but does not contain bits of picture v₃. The decoder cannot start decoding coded pictures of stream w until at least time DT_{w3}, where DT_{w3} is the decode time for picture w₃, in order to allow the buffer to fill with bits of stream w. In addition, the decoder must wait for an I picture before starting to decode the wᵢ bits. The decoder will be able to decode pictures v₀, v₁ and v₂ at times DTS₀, DTS₁ and DTS₂, but assuming a buffer size Ts, and assuming that frame w₃ is an I frame, it may not be able to start decoding frames of the stream wᵢ until time t′₃+Ts, where t′₃ is the time of arrival of the first bit of picture w₃. Consequently, the channel change delay depends on the size of the compressed video buffer and the location of any given compressed frames within the buffer. In the case of this example the STB must repeat frame v₂ at DTS₃, DTS₄ and DTS₅, at least, before it is able to present a picture of the stream w. Moreover, in general the first frame after a channel change request will not be an I frame, so the number of times that the STB must repeat frame v₂ will normally be larger, and the additional channel change delay could be as long as two seconds. This delay may be disturbing to a user who expects a substantially instantaneous response to a channel change request.

### BRIEF DESCRIPTION OF THE DRAWINGS

For a better understanding of aspects of the invention, and to show how the same may be carried into effect, reference will now be made, by way of example, to the accompanying drawings. It will be understood that this invention is not limited to the precise arrangements and instrumentalities shown.

FIG. 1 is a schematic illustration of parts of a switched digital video distribution infrastructure including a DSLAM.

FIG. 2 is a schematic block diagram of a DSLAM included in a switched digital video distribution infrastructure.

FIG. 3 is a graph illustrating operation of the switched digital video distribution infrastructure in response to a channel change request.

FIG. 4 is a schematic block diagram of a modified DSLAM, which may be included in a digital video distribution infrastructure in accordance with an embodiment of the invention.

FIG. 5 is a partial schematic block diagram of an STB that may be included in the digital video distribution infrastructure described with reference to FIG. 4, in accordance with an embodiment of the invention.

FIG. 6 is a graph illustrating operation of the digital video distribution infrastructure described with reference to FIG. 4 in response to a channel change request, in accordance with an embodiment of the invention.

FIG. 7 is a graph illustrating a modification of the mode of operation described with reference to FIGS. 4-6, in accordance with an embodiment of the invention.

FIG. 8 is a partial schematic illustration of a modified DSLAM that may be used to implement the operation described with reference to FIG. 7, in accordance with an embodiment of the invention.

FIG. 9 is a simplified block diagram of a computing machine that may be used to implement a portion of the infrastructure described below, in accordance with an embodiment of the invention.

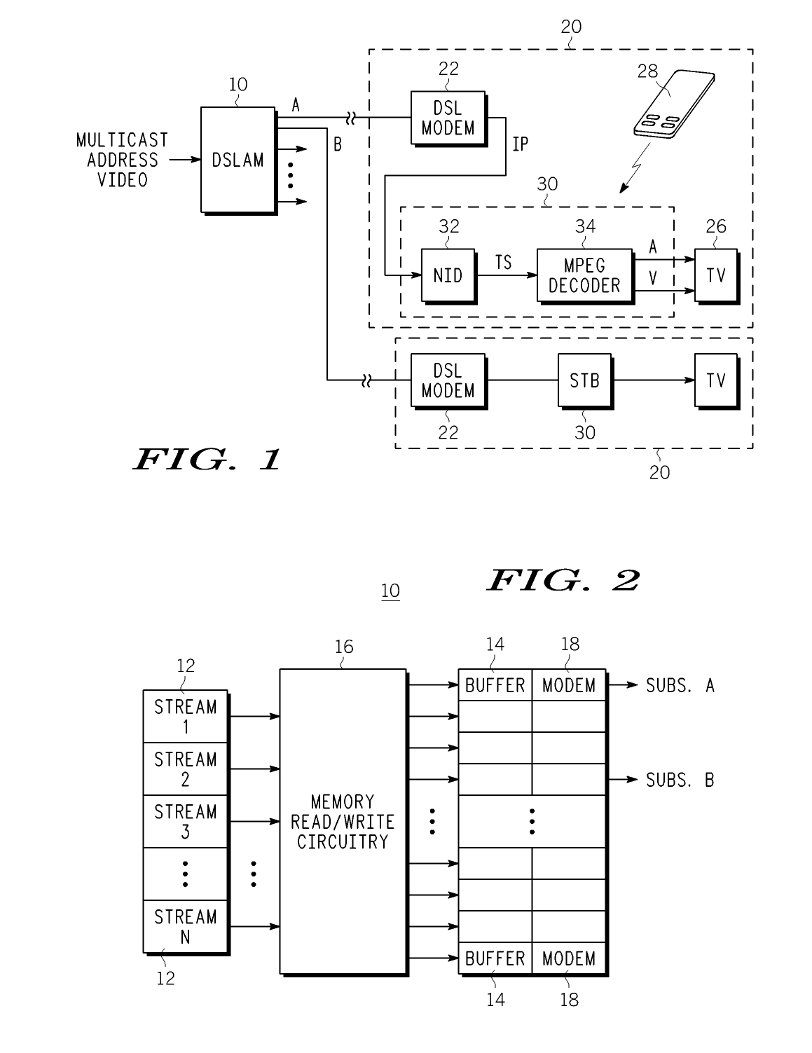

In the several figures of the drawings, like reference numerals denote like or corresponding components.

### DETAILED DESCRIPTION

An embodiment of the present invention mitigates channel change delay by temporarily reducing the maximum time difference DTSᵢ−tᵢ, by increasing the bit rate so that DTSᵢ−tᵢ is always less than one frame time. This may be accomplished by supplying the STB not only with the CBR regular stream (“SR”) of the requested program but also with a VBR fast channel change stream (“SF”). The fast channel change stream SF may be generated upstream of the DSLAM, but in some embodiments, it is preferred that the fast channel change stream be generated internally of the DSLAM.

Referring to FIG. 4, the DSLAM has a pair of input buffers for each input stream. One member of the pair (SR) receives the regular stream SR and the other member (SF) receives the fast channel change stream SF, which is derived from the regular stream SR by applying the following constraints to the regular stream:

a) All null (PID 8191) packets in SR are removed.

b) The PAT, PMT, and other tables are placed at the same time (relative to PCR) in SF as in SR.

c) Audio packets and any other non-video and non-table packets are placed at the same time (relative to PCR) in SF as in SR.

d) The coded picture bits, vᵢ, in the TS packets for video frame i are placed in SF such that all the packets are sent no earlier than DTSᵢ₋₁ and arrive no later than DTSᵢ. This is graphically demonstrated in FIG. 6.

e) For any given PID the TS packets in temporal order in SR are (bit-by-bit) identical to the TS packets in SF except that a PCR in the adaptation_field of any TS in SF is adjusted for its position in the stream.

The constraints a)-e) may be applied upstream of the DSLAM or in the DSLAM itself.

The two streams (SR and SF) are transmitted such that if both are sent over the same network interface, TS packets from the two streams whose associated system clocks have the same or very close values will show up on the network interface very close in time.

Constraint a) ensures that the number of bits to be included in the stream SF is kept to a minimum, thus facilitating transmission at VBR. The other constraints ensure that substantially the only difference between the streams is the values of the PCRs.

The R/W circuitry 16 constructs the transport stream that is delivered to each subscriber buffer based on the IGMP leave and join requests received from the subscriber's STB. Thus, if subscriber A issues a command to change from the channel associated with stream X to the channel associated with stream 1, subscriber A's STB issues a leave request with respect to the multicast group for stream X and issues join requests with respect to the multicast groups for both the regular and fast channel change streams for stream 1. The R/W circuitry 16 places packets of the respective streams (SF and SR) in the subscriber A output buffer 14.

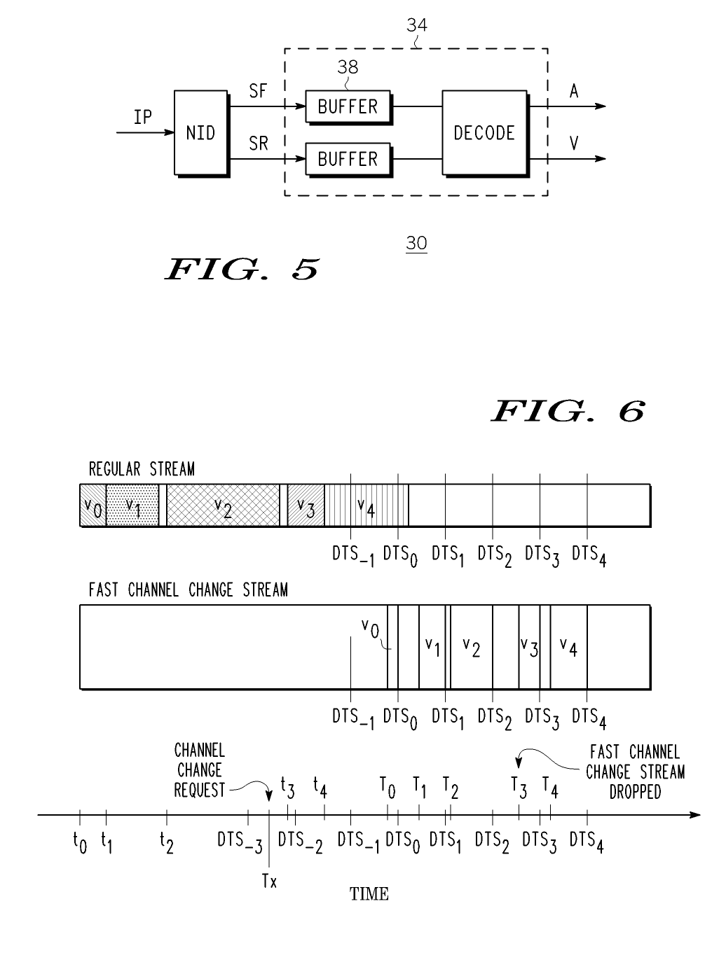

As noted above, the conventional MPEG decoder shown in FIG. 1 includes a decoder buffer, which receives the TS packets from the network interface device. As shown in FIG. 5, in the illustrated infrastructure the MPEG decoder includes two decoder buffers 36, 38 for receiving the regular stream and the fast channel change stream respectively. The audio and video decoders select the outputs of the two buffers for decoding depending based on the stream that is to be currently decoded.

The upper rectangle in FIG. 6 depicts transport stream bits of the normal CBR stream SR conveying pictures vᵢ delivered to the output buffer 14 of a subscriber that is a member of the multicast group for stream 1. The lower rectangle represents a segment of the corresponding fast channel change stream SF, which is received (or generated internally) continuously by the DSLAM but would only be delivered to a member of the multicast group for stream 1 for a short time after becoming a member of the multicast group. The peak rate of the fast channel change stream is higher than the constant bit rate of the regular stream (represented schematically by the greater height of the lower rectangle) although the average bit rate of the fast channel change stream is not higher than the constant bit rate of the regular stream. It will be seen from FIG. 6 that the picture vᵢ is placed in the fast channel stream within the time interval between DTSᵢ₋₁ and DTSᵢ. Although the picture vᵢ included in the fast channel change stream arrives at the STB later than the picture vᵢ in the regular stream, the delay between arrival at time Tᵢ of the first bit of a picture of the fast channel stream and the decode time DTSᵢ for that picture is less than the interval between two consecutive decode times.

In the event that the fast channel change stream SF is generated internally of the DSLAM, the block 12A may be considered to represent both the means for generating the stream SF and the input buffer for the stream SF.

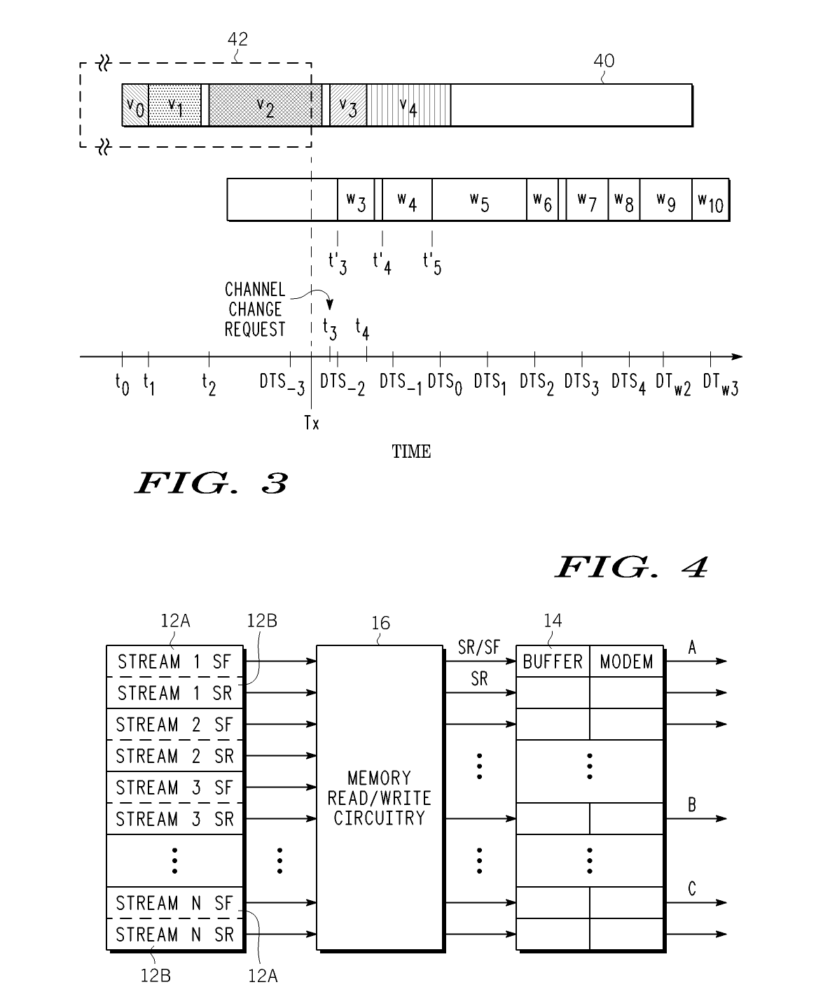

Similarly to the case described with reference to FIG. 3, at time Tx, subscriber A's STB issues join requests with respect to stream 1. At time t₃, the two streams (SF and SR) start arriving at subscriber A's STB and the STB can start buffering v₃ from the regular stream SR. The STB can start buffering v₁ from the fast channel change stream SF at time T₁ and can decode the picture v₁ at time DTS₁.

Let us assume as before that the picture v₁ is the first I picture of the requested channel after the channel change request. The decoder is able to start decoding picture v₁ received in the fast channel change stream within no more than one picture interval after receiving the first bit of picture v₁ and without waiting for a time Ts to elapse in order to fill the decoder buffer. Thus, by use of the fast channel change stream, we are able to reduce the maximum time difference DTSᵢ−Tᵢ and thereby reduce the channel change time.

The first picture of the regular stream to be received after the channel change request is picture v₃. Therefore, at time DTS₃ the regular stream has caught up with the fast channel change stream and the decoder can switch from using the pictures of the fast channel change stream to using the pictures of the regular stream. At time T₃ the STB issues a leave request with respect to the fast channel change stream and the R/W circuitry 16 responds by removing subscriber A's STB from the multicast group for the stream SF.

Constraint d) ensures that the audio frames in stream SF are placed in the stream near the decode times for the corresponding video and so can be decoded and played out at the same time as a video frame.

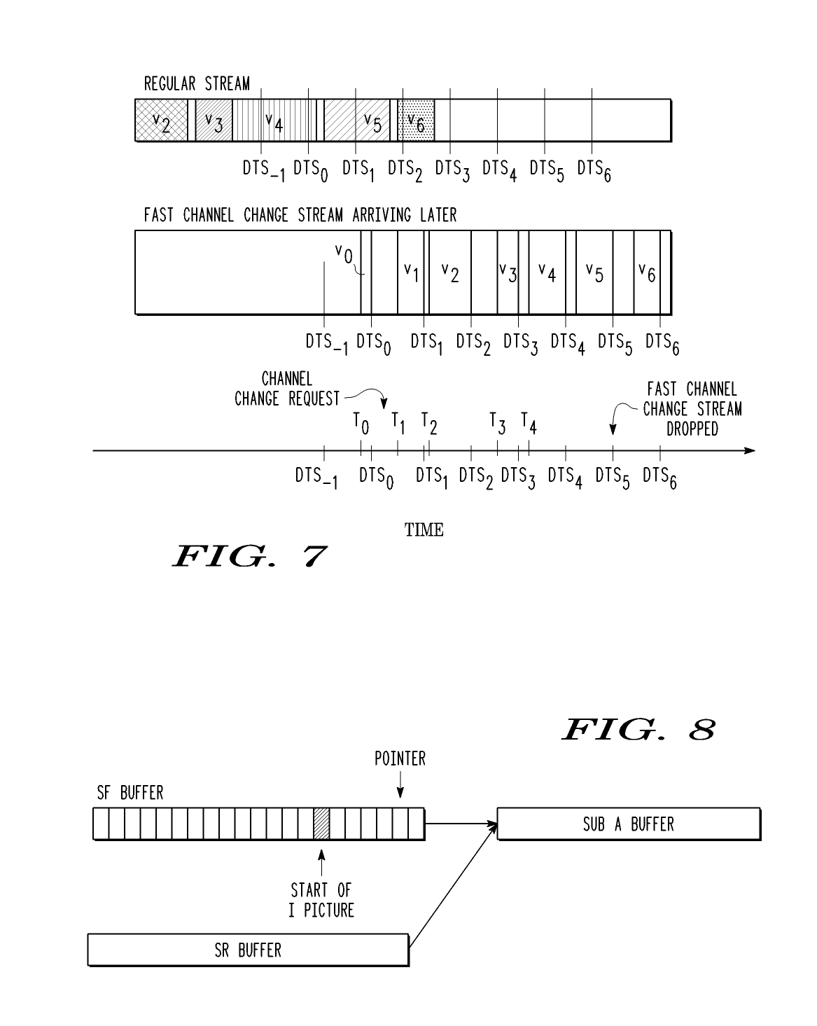

Referring to FIG. 7, in a further development we achieve a reduced delay in accessing the start of an I picture in the SF stream by allowing the TS packets of the stream SF to arrive at the STB later than the TS packets of the stream SR. FIG. 7 shows the fast channel change stream SF to be arriving about 1.5 frame times later than the regular stream SR. After the STB sends the IGMP join requests for the streams SF and SR, assume that the streams start arriving at the STB at the time indicated by the label “channel change request.” At time T₁ the STB can start buffering video of the stream SF and can start decoding at time DTS₁ (since we have assumed that v₁ is an I picture). Because of the offset in arrival time, the time at which the regular stream SR catches up with the fast channel change stream SF is delayed compared with the case described with reference to FIG. 6 and the regular stream SR does not catch up with the fast channel change stream SF until the time marked “fast channel change stream dropped.” However, the channel change time attributed to the encoder remains small since the interval between arrival of the first bit of picture vᵢ and DTSᵢ remains less than the interval between two consecutive decode times. Allowing additional latency gives the opportunity for selecting the time offset so that the channel change request point always occurs in the fast channel change stream just before an I picture.

FIG. 8 shows a model of one of the pairs of input buffers in the DSLAM. The SR buffer receives IP packets of an incoming multicast stream. Copies of the contents of the SR buffer are made and placed in transport streams that are supplied to the output buffers associated with the members of the multicast group for that stream. Similarly, the SF buffer receives IP packets derived from the same incoming stream by applying the constraints discussed above, either internally of the DSLAM or upstream of the DSLAM.

The fast channel change stream input buffer has a minimum size g*R bits where g is the maximum time (in seconds) between two consecutive I pictures and R is the peak bit rate (in bits/second) of the stream SF. Accordingly, the SF buffer always contains at least one I picture.

The DSLAM analyzes the IP packets of the stream SF and those that contain the start of an I picture are marked as such in the fast channel change stream buffer.

When the DSLAM receives a join request with respect to the multicast group of a fast channel change stream, the DSLAM creates a pointer for the requesting subscriber having regard to the packets that are marked as containing the start of an I picture. The pointer marks the point from which the router reads IP packets from the SF buffer for copying to the subscriber's output buffer. As packets are copied, the pointer is updated appropriately. Initially, the pointer points logically to the location in the SF buffer containing the IP packet that contains the start of the most recent I picture in the stream SF. Therefore, the first picture that the STB receives in the fast channel change stream is always an I picture. In order to accommodate possible processing delays, it may be necessary that the pointer should initially point to an IP packet that is slightly upstream of the IP packet containing the start of the most recent I picture in the stream SF. Nevertheless, the first picture that the STB receives in the stream SF is the most recent I picture in the stream SF.

The requirement regarding buffer size may be relaxed to g*R_{avg}, where R_{avg} is the average bit rate, provided data can be burst at the peak bit rate and time stamps are added to the packets in the buffer to enable them to be burst out at the appropriate time.

When the DSLAM receives a leave request with respect to the multicast group of a fast channel change stream, the DSLAM deletes the pointer for the requesting subscriber.

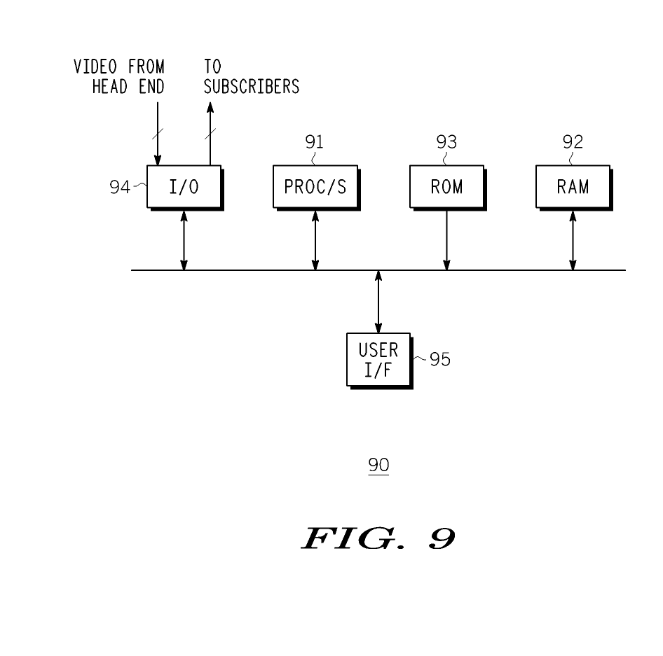

Referring to FIG. 9, suitable distributor premise equipment may be implemented using a computer 90 comprising one or more processors 91, random access memory 92, read-only memory 93, I/O devices 94 and a user interface 95, configured in a generally conventional architecture, wherein the computer is programmed to allocate memory to the input and output buffers and to utilize other suitable resources and functions, such as copying data from the input buffers to the output buffers, to perform the various operations that are described above as being performed by the distributor premise equipment.

The pictures may be transmitted in unencrypted form, or they may be transmitted in encrypted form and decrypted by the subscriber premise equipment.

It will be appreciated that the invention is not restricted to the particular embodiments that have been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. For example, although in the embodiments described above the regular MPEG transport streams SR are supplied to the STB at constant bit rate, the invention is also applicable to the case in which the regular transport streams are supplied at capped VBR. In addition, although the invention has been described in the context of a DSLAM connected by copper wire to the subscriber premises, the invention may also be implemented in other network access equipment, such as an optical line terminal (OLT) connected to the subscriber premises by optic fiber. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of operating a switched digital video distribution infrastructure for selectively distributing transport streams each composed of encoded pictures for decoding and presentation, wherein the infrastructure comprises source apparatus and a plurality of destination devices each including a decoder buffer, said method comprising:
at the source apparatus, outputting a first program to a requesting destination device as a constrained bit rate transport stream, receiving a program change request from the requesting destination device, and in response to the program change request, outputting a second program both as an unconstrained variable bit rate stream and as a constrained bit rate transport stream,
at the requesting destination device, decoding the unconstrained variable bit rate transport stream, loading the second program's constrained bit rate transport stream into the decoder buffer until the decoder buffer contains sufficient data to allow the pictures of the second program's constrained bit rate transport stream to be decoded without the decoder buffer running dry, and then commencing reading the second program's constrained bit rate transport stream from the decoder buffer and decoding the pictures of the second program's constrained bit rate transport stream and discontinuing decoding of the unconstrained variable bit rate transport stream.

2. A method according to claim 1, wherein the source apparatus includes a digital subscriber line access multiplexer (DSLAM) comprising:
for each of a plurality of available programs, a first input buffer for receiving the transport stream at a constrained bit rate and a second input buffer for receiving the transport stream at an unconstrained variable bit rate,
an output buffer for each destination device, and
a selective connection means for supplying the constrained bit rate and unconstrained variable bit rate transport streams from the first and second input buffers for any selected available program to any selected unique group of output buffers.

3. A method according to claim 1, wherein the source apparatus includes a digital subscriber line access multiplexer (DSLAM) comprising:
for each of a plurality of available programs, a first input buffer for receiving the transport stream at a constrained bit rate, a means for receiving the transport stream and generating a version of the transport stream at an unconstrained variable bit rate, and a second buffer for receiving said version at an unconstrained variable bit rate,
an output buffer for each destination device, and
a selective connection means for supplying the constrained bit rate program stream and the unconstrained variable bit rate version of the program stream from the first and second input buffers for any selected available program to any selected unique group of output buffers.

4. A method according to claim 1, wherein the source apparatus includes a digital subscriber line access multiplexer (DSLAM) that includes an output buffer for each destination device and the method comprises supplying the second program's constrained bit rate transport stream to the DSLAM as a first sequence of single program transport stream packets, supplying the unconstrained variable bit rate transport stream to the DSLAM as a second sequence of single program transport stream packets, and, responsive to a channel change request, supplying both the first and second sequences of single program transport stream packets to the subscriber output buffer for the requesting destination device.

5. A method according to claim 4, wherein the requesting destination device issues an IGMP leave request specifying the second sequence of single program transport stream packets when the decoder buffer contains sufficient data to allow the pictures of the second program's constrained bit rate transport stream to be decoded without the decoder buffer running dry, and the source apparatus, responsive to the leave request, discontinues supplying the second sequence of single program transport stream packets to the subscriber output buffer.

6. A method according to claim 5, wherein the program change request issued by the requesting destination device is an IGMP join request specifying the second sequence of single program transport stream packets and is issued by the requesting destination device in response to a subscriber command inputted to the requesting destination device.

7. A method according to claim 4, wherein the first and second sequences of single program transport stream packets are encapsulated in streams of IP packets.

8. A method according to claim 2, comprising:
for each of said available programs, loading the constrained bit rate program stream into the first buffer and loading the unconstrained variable bit rate program stream into the second buffer,
receiving the program change request from the requesting destination device, wherein the program change request specifies one of said available programs, and
copying the constrained bit rate and unconstrained variable bit rate streams from the first and second input buffers for the specified available program to the output buffer for the requesting device.

9. A method according to claim 8, wherein the unconstrained variable bit rate transport stream comprises a sequence of compressed pictures including intra-coded pictures and predictive coded pictures, there is a predetermined maximum interval between consecutive intra-coded pictures in the unconstrained variable bit rate transport stream, the second input buffer is of sufficient size relative to said predetermined maximum interval to contain at all times at least one intra-coded picture, and the method comprises:
analyzing the packets of the unconstrained variable bit rate transport stream and marking a packet that contains the start of an intra-coded picture,
in response to a request from the destination device, creating a pointer to a location in the second input buffer that contains a marked packet, and
commencing copying from the second buffer at said location.

10. A method according to claim 9, wherein each picture has an associated decode time and the method comprises loading the unconstrained variable bit rate transport stream into the second input buffer until the decode time for the first picture loaded into the first input buffer and then deleting the pointer.

11. A method according to claim 2, wherein the unconstrained variable bit rate transport stream is a sequence of compressed pictures each having an associated decode time, and the method comprises loading the unconstrained variable bit rate transport stream into the second input buffer until the decode time for the first picture loaded into the first input buffer.

12. A method according to claim 1, comprising outputting the first program to the requesting destination device as a constant bit rate transport stream and outputting the second program to the requesting destination device both as an unconstrained variable bit rate transport stream and as a constant bit rate transport stream.

13. A method according to claim 1, wherein the unconstrained variable bit rate transport stream is a sequence of compressed pictures each having an associated decode time, and the method comprises transmitting a picture of the unconstrained variable bit rate transport stream to the requesting destination device starting no sooner than the decode time associated with the next preceding picture.

14. A switched digital video distribution infrastructure for selectively distributing a plurality of available transport streams each composed of encoded pictures for decoding and presentation, wherein the infrastructure comprises source apparatus operative to:
output a first program as a constrained bit rate transport stream,
receive a program change request specifying a second program,
in response to the program change request, discontinue outputting the first program and commence outputting the second program both as an unconstrained variable bit rate transport stream and as a constrained bit rate transport stream,
receive a leave request, and
in response to the leave request, discontinue outputting the unconstrained variable bit rate transport stream while continuing to output the second program as a constrained bit rate transport stream.

15. An infrastructure according to claim 14, wherein the program change request comprises a leave request and a join request provided by a requesting destination, and in response to the leave request the source apparatus causes the requesting destination to leave a multicast group for receiving the first program, and in response to the join request the source apparatus causes the requesting destination to join a multicast group for receiving the second program.

16. An infrastructure according to claim 14, wherein the source apparatus comprises a digital subscriber line access multiplexer including a plurality of input buffer means each for receiving an available input program both as an unconstrained variable bit rate transport stream and as a constrained bit rate transport stream, multiple output buffers associated with the destinations respectively, and a selective connection means for copying data from any selected input buffer means to any unique group of output buffers.

17. An infrastructure according to claim 14, wherein the source apparatus includes:
an input buffer for receiving the unconstrained variable bit rate transport stream,
multiple output buffers associated with the destinations respectively, and
a selective connection means for copying data from the input buffer to any unique group of output buffers,
the unconstrained variable bit rate transport stream output by the source apparatus comprises a sequence of compressed pictures including intra-coded pictures and predictive coded pictures, there is a predetermined maximum interval between consecutive intra-coded pictures in the unconstrained variable bit rate transport stream, the input buffer is of sufficient size relative to said predetermined maximum interval to contain at all times at least one intra-coded picture, and the source apparatus is operative to:
analyze the packets of the unconstrained variable bit rate transport stream and mark a packet that contains the start of an intra-coded picture,
in response to a request from the destination device, create a pointer to a location in the input buffer that contains a marked packet, and
commence copying from the input buffer at said location.

18. A switched digital video distribution infrastructure for selectively distributing transport streams each composed of encoded pictures for decoding and presentation, wherein the infrastructure comprises:
source apparatus operative to output a first program as a constrained bit rate transport stream to a requesting destination device, receive a program change request from the requesting destination device, and in response to the program change request, output a second program both as an unconstrained variable bit rate transport stream and as a constrained bit rate transport stream, and
a plurality of destination devices each including a decoder buffer and each operative to decode the unconstrained variable bit rate transport stream, load the second program's constrained bit rate transport stream into the decoder buffer until the decoder buffer contains sufficient data to allow the pictures of the second program's constrained bit rate transport stream to be decoded without the decoder buffer running dry, and then commence reading the second program's constrained bit rate transport stream from the decoder buffer and decode the pictures of the second program's constrained bit rate transport stream and discontinue decoding of the unconstrained variable bit rate transport stream.

19. An infrastructure according to claim 18, for selectively distributing transport streams to multiple destinations for decoding and presentation, wherein the source device outputs a sequence of IP packets in which the second program's constrained bit rate transport stream and the unconstrained variable bit rate transport stream are encapsulated, each destination device comprises a network interface device for receiving the IP packets and outputting both the unconstrained variable bit rate transport stream and the second program's constrained bit rate transport stream, and a decoder for decoding pictures of the second program's constrained bit rate transport stream and of the unconstrained variable bit rate transport stream.

20. A method of processing a constrained bit rate transport stream comprising a sequence of compressed pictures including intra-coded pictures and predictive coded pictures, the method comprising:
generating an unconstrained variable bit rate transport stream from the constrained bit rate transport stream, the unconstrained variable bit rate transport stream being composed of a sequence of transport stream packets and there being a predetermined maximum interval between consecutive intra-coded pictures in the unconstrained variable bit rate transport stream,
loading the unconstrained variable bit rate transport stream into an input buffer of sufficient size relative to said predetermined maximum interval to contain at all times at least one intra-coded picture,
analyzing the packets of the unconstrained variable bit rate transport stream and marking a packet that contains the start of an intra-coded picture,
in response to a request from a destination device, creating a pointer to a location in the input buffer that contains a marked packet, and
copying packets from the input buffer to an output buffer starting at said location.

21. A method according to claim 20, wherein the constrained bit rate transport stream is composed of a sequence of transport stream packets, the method comprises:
loading the unconstrained variable bit rate transport stream into a first input buffer,
loading the constrained bit rate transport stream into a second input buffer,
copying packets from the first input buffer to the output buffer as a first transport stream, and
copying packets from the second input buffer to the output buffer as a second transport stream,
and wherein the pictures of the unconstrained variable bit rate transport stream are delayed relative to the pictures of the constrained bit rate transport stream.

22. A computer readable medium containing instructions that, when executed by a computing machine receiving a plurality of available input transport streams each composed of encoded pictures for decoding and presentation, cause the computing machine to:
output a first program as a constrained bit rate transport stream, and
in response to a program change request specifying a second program, discontinue outputting the first program and commence outputting the second program both as an unconstrained variable bit rate transport stream and as a constrained bit rate transport stream.

23. A computer readable medium according to claim 22, containing instructions that cause the computing machine to respond to a leave request by discontinuing outputting the unconstrained variable bit rate transport stream while continuing to output the second program as a constrained bit rate transport stream.
